(19) United States
(12) Patent Application Publication
(10) Pub. No.: US 2009/0312167 A1
(43) Pub. Date: Dec. 17, 2009

(54) Wire-Wound Engraving Roller and Method of Manufacturing the Same

(76) Inventor: Håkan Karlsson, Saffle (SE)

Correspondence Address: NIXON & VANDERHYE, PC, 901 NORTH GLEBE ROAD, 11TH FLOOR, ARLINGTON, VA, 22203, US

(21) Appl. No.: 12/226,059

(22) PCT Filed: Feb. 27, 2007
(86) PCT No.: PCT/SE2007/050117

§ 371 Date: Dec. 2, 2008

(30) Foreign Application Priority Data
Apr. 11, 2006 (SE) 0600823-9

(51) Int. Cl. A01B 29/06; B21D 35/00

(52) U.S. Cl. 492/30; 29/469.5

(57) ABSTRACT

The present invention relates to a method in connection with the manufacturing of a dosing roller, comprising the provision of a roller body (1) with an envelope surface (IA) on which a wire (4) is being wound such that plurality of turns of wire is formed in contact with the envelope surface (IA) and with adjoining turns of wire (4, 4′, 4′) in tight contact with each other, wherein for at least the major part of said adjoining turns of wire (4, 4′, 4′) the surface of the wire (4) which is outwardly exposed is being provided with protrusions (11) and depressions (12).

The present invention relates to an engraving roller that is manufactured by tightly winding section wire to form a surface layer on the roller.

### PRIOR ART

A method of coating running webs, paper webs in particular, is by so called predosed roller coating. In the method, the running web passes through a roller nip in which a predosed amount of coating mix is transferred to one or both sides of the web. In some cases, the transferring nip can be formed from one roller on one side and a resilient blade on the other side.

Usually, the controlled predosing to the transferring roller takes place by so called rotary rods. Such rods may have a smooth or embossed surface. If the surface of the rod is smooth, the dosed amount will depend on the force of the rod on the transferring roller. This type of dosing is called hydrodynamic dosing. If the rotary rod has an embossed surface, the predosed amount will be mainly volumetric, i.e. the predosed amount is determined by the amount of coating mix that the depressions in the rod surface are able to accommodate. A drawback of this method is that the amount of coating mix only can be affected by the depth of the depressions and the properties of the coating mix.

A long known predosing method is to use an engraving roller having an “engraving pattern” comprising closed cells on the surface of the dosing roller. By using closed cells, the dosed amount can be controlled by the rotational speed of the dosing roller.

By closed cells on the surface of the dosing roller are meant depressions/indentations in the surface which are separate from each other. Usually, these depressions/indentations have the shape of pyramids.

It is however costly and cumbersome to produce the engraving pattern and usually this takes place mechanically by an embossing tool that is limited in width and that is pressed against the roller surface and is successively fed over the entire roller surface, which takes quite some time. Usually, the embossing takes place according to one of two main principles:

One principle is “embossing” directly in the supporting roller jacket that is usually of steel. This method however has the major drawback that a large embossing force is required to achieve the desired indentations, which may result in the straightness of the roller being affected. Another significant drawback is that the thickness of the roller jacket gets reduced when the embossing is to be renovated after wear by turning down remaining material of the old embossing before performing new embossing.

According to the second principle embossing takes place in a material that has been applied on the steel jacket. The applied material is softer and usually consists of copper that is applied by an electrolytic method. The coating by a softer material has the advantages that embossing is facilitated since the embossing force can be reduced and that embossing takes place only in the soft material that can be renovated without affecting the supporting roller jacket. The drawback is however that the soft material has low resistance to wear, which means that a wear layer, usually of chromium, must be applied on top of the embossed, soft layer. Accordingly, three complex and advanced operations are required, which means a long lead time and a high production cost for the embossed surface. The risk of cassation, due to possible mistakes in the line of production or handling damages, is also a major drawback.

Finally, SE 9001219-6 describes a volumetric predosing roller coating method, in which the dosing takes place by a cantilever roller the surface of which is provided with parallel circumferential grooves or channels. These grooves or channels are achieved by wire (usually having a round profile) that is tightly wound on the roller surface, which is considerably much cheaper and less complex than the manufacturing of a traditional engraving roller. Coating mix is continuously supplied to the depressions between the turns of the wire, during operation, and this coating mix is then transferred to the transferring roller. In this method it is the depth of the depressions, determined by the diameter of the wire, that affects the volume of the predosed amount. The method will give uniform dosing longitudinally as well as across the running direction of the web. It is however a drawback of the method that the dosed amount can not be controlled by machine adjustment during operation, but depends completely on the diameter of the wire and the properties of the coating mix.

Yet another method of manufacturing engraving rollers exists, in which the surface of the supporting roller jacket is coated with a durable ceramic material such as tungsten carbide, after which the engraving is made by laser. This method of manufacturing is however very costly and it also has the drawback that the smoothness of the surface gets worse than with the above mentioned traditional methods. A poor smoothness of the surface means a greater risk of clogging of the engraved depressions by coating mix.

### New Technique

The object of the present invention is to eliminate or at least diminish the problems associated with known traditional production methods according to the above, which is achieved by a method according to claim 1.

Thanks to the invention it is possible in a faster and cheaper way to manufacture a dosing roller with engraved surfaces, resulting in a more cost efficient manner than before to manufacture a dosing roller that makes it possible during operation to adapt the amount dosed out, by adjusting the speed of rotation.

In a preferred embodiment, the new technique is based on tight winding of pre-engraved wire on the roller jacket. In a preferred embodiment, the engraving pattern consists of rack-like grooved in the cross direction of the wire. The engraving pattern is embossed on the wire either in connection with the winding or in a separate operation. The wire material is preferably stainless steel but in particular cases it can consists of some other alloy such as copper. In yet other particular cases, the wire may be a polymer. The profile of the wire may vary within wide limits. The side opposite to the engraved side may for example have a completely or partially flat surface in order to achieve good contact with the roller jacket. In some cases, the side surfaces of the wire may also be more or less flat in order to achieve a better contact with the adjacent turns of wire. In some particular cases, the wire may also have a completely square or rectangular profile.

In yet another particular embodiment of the invention, a non-engraved, completely square or rectangular wire is tightly wound. In this case, the engraving is traditionally made in a subsequent separate operation.

The cross-section of the wire is usually in the range of 0.01-0.2 mm², but in some cases it could also be in the range of 0.007-20 mm².

In order to make sure that the tightly wound wire does not slide on the support, the wire is pretensioned in connection with the winding. In some cases, gluing can be made in order to improve contact with the support.

### BRIEF DESCRIPTION OF THE DRAWINGS

In the following, the invention will be described in detail with reference to the attached drawing figures, of which:

FIG. 1 shows a preferred embodiment of an apparatus for winding wire and simultaneously embossing the wire in order to manufacture a dosing roller according to the invention,

FIG. 2 shows a view in perspective of a section of a dosing roller provided with an embossed wire according to the invention,

FIG. 3 shows the cross-section III-III in FIG. 2,

FIG. 4 shows a modified section of a dosing roller according to the invention,

FIG. 5 shows the cross-section V-V in FIG. 4,

FIG. 6 shows yet a modified embodiment according to the invention,

FIG. 7 shows yet a modified embodiment of a section of a dosing roller according to the invention,

FIG. 8 shows the cross-section VIII-VIII in FIG. 7,

FIG. 9 shows yet a modified embodiment of a section according to the invention,

FIG. 10 shows the cross-section X-X in FIG. 9,

FIG. 11 shows yet a modified embodiment of a section according to the invention,

FIG. 12 shows yet a modified embodiment of a section according to the invention, and

FIG. 13 shows yet a modified embodiment of a section according to the invention.

### DETAILED DESCRIPTION OF THE INVENTION

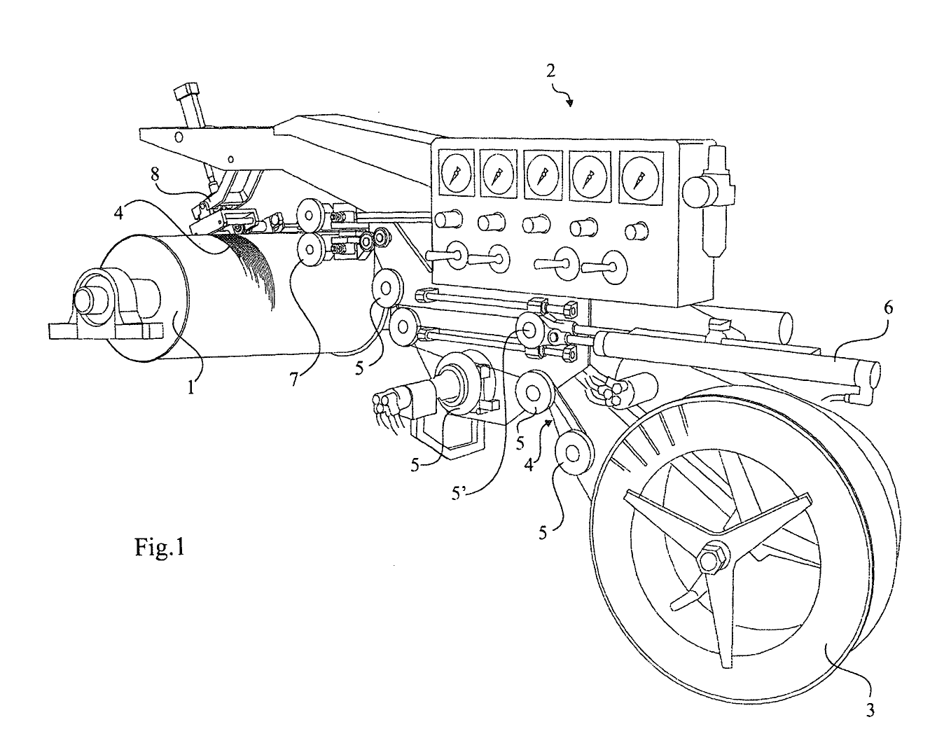

FIG. 1 shows wire 4 coating by wire-winding a dosing roller 1 by aid of a wire-winding unit (generally denoted 2). The wire-winding unit 2 comprises among other things a device 7 that profiles and embosses the wire 4, as well as a device that pretensions the wire 4. The unit 2 is displaced in parallel with the rotation/centre axis at the same time as the roller 1 is rotated, with a displacement rate that per turn of the roller corresponds to the axial width of the wire in respect of the roller. The figure does not show the actual displacement feeding mechanism for the unit that (according to known technique) can be a traditional lathe. The starting material for the winding process is wire 4 that is being unwound from a bobbin 3. The wire 4 is guided and its tension is increased by a number of guide wheels 5 of which at least one is tension loaded by aid of a cylinder/piston unit 6. By braking the guide wheels 5, additional pretension is created in the wire 4. The braking force, and thereby the wire tension, is adjustable and is controlled by the tensioning unit 6. Embossing and profiling takes place in the embossing works 7. In order to secure good contact between the wire turns, the unit is equipped with a pressing device 8 that, when the wire 4 is coated onto the roller 1, presses the outermost turn of wire against the outermost but one turn of wire.

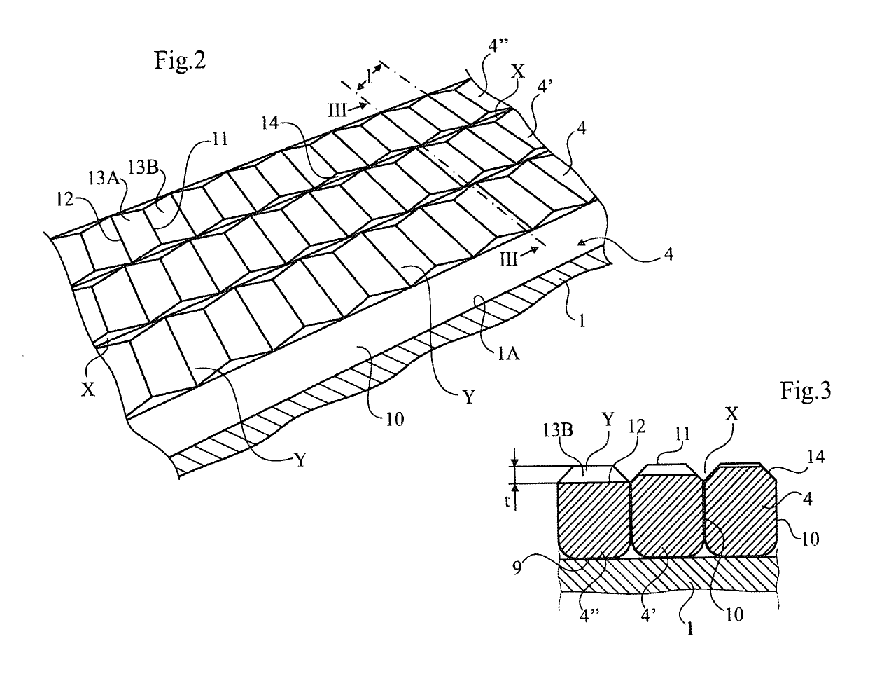

FIGS. 2 and 3 show a first preferred embodiment of a dosing roller according to the invention. Only a limited section of such a roller 1 is shown, which section comprises an outer layer of three adjoining embossed wires 4, 4′, 4″. Each wire 4 is embossed with a rack-like pattern exhibiting a uppermost point 11 and a lowermost point 12. The uppermost point 11 is a line that extends perpendicularly from side to side in respect of the longitudinal direction of the wire. Also the valleys 12 form a line that extends from side to side, i.e. in parallel with the peaks 11. Between the peaks 11 and the valleys 12 there are flat, outwardly inclined surfaces 13A, 13B, such that as seen from the side a wide angled V is formed from side surfaces 13A, 13B of the profiles, the angle between adjoining side surfaces 13A, 13B suitably exceeding 45°, more preferably exceeding 90°. The toothed pattern is accordingly embossed in connection with the winding of the wire, by aid of the embossing unit 7 (see FIG. 1) or, alternatively, pre-embossed wire is used that after the embossing is stored on a suitable unwinding unit, such as a bobbin/drum 3 according to FIG. 1.

It is clear from FIG. 2 not only that the outwardly facing surface of the wire can be shaped/embossed, but also the other surfaces 9, 10. it is clear that the side surfaces 10 of this embodiment are embossed to be essentially plane, as is the surface 9 that faces inwards, towards the roller surface 1A. It is realised that different embossing shapes will result in different properties and that hence, the invention offers a unique possibility of adapting the embossing/shaping in order to fulfil varying unique client desires/needs. The embossing has a depth t, between the peak 11 and the valley 12, that varies between about 0.01 and 1 mm. The width of the rectangular, almost square, wire 4 is about 0.1-4 mm, preferably 0.2-0.5 mm.

It is also clear from FIGS. 2 and 3 that the edge portions 14, at the transition between the outwardly facing surface and the side surfaces 10, are bevelled (suitably by an angle of between 30 and 60°) such that longitudinal channels are formed that extend in the longitudinal direction of the wire, which channels to some extent is in communication with the space with a lateral extension delimited by the outwardly directed surfaces 13A, 13B.

The wire is wound in contact with the roller surface 1A by a desired tensional force (suitably in the range of 50-1500N/mm² depending on the material of the wires), such that there is always a tension load in the applied wire 4, and as a result thereof a compressive force is formed between the backside of the wire 4 and the roller surface 1A. The application is also made (achieved by the pressing unit 8) such that there is a certain compressive stress between the contact side surfaces 10 of two adjoining wires 4. The force can be varied between 10 and 120 N, normally 40-60 N. The compressive stress can be varied between 3 and 400 N/mm², normally 20-150 N/mm².

As is clear from FIG. 2, the offset between peaks 11 as well as valleys 12 between two adjoining turns of wire 4 (such as 4′, 4″) will be stochastic, such that peaks 11 will sometimes end up aligned with the valleys 12 of the adjoining wire 4 and sometimes the offset will be some other one. In any case, the pattern embossed in the surface structure of tightly wound wire 4 will create rooms Y with limited ability of viscous intercommunication, such that rooms/cells Y are created that are practically closed, thereby enabling a volumetric dosing that can be controlled by the rotary speed of the dosing roller 1. It is also clear from FIGS. 2 and 3 that thanks to the flexible method of production according to the invention, it is possible to create longitudinal channels X (limited in depth) between the turns of wire 4, 4′ by arranging bevelled side surfaces 14. By the arrangement of these circumferential channels X, yet another variable can hence be used to optimise the dosing out from the roller 1, as these can be used to create a certain compensating effect between the rooms Y.

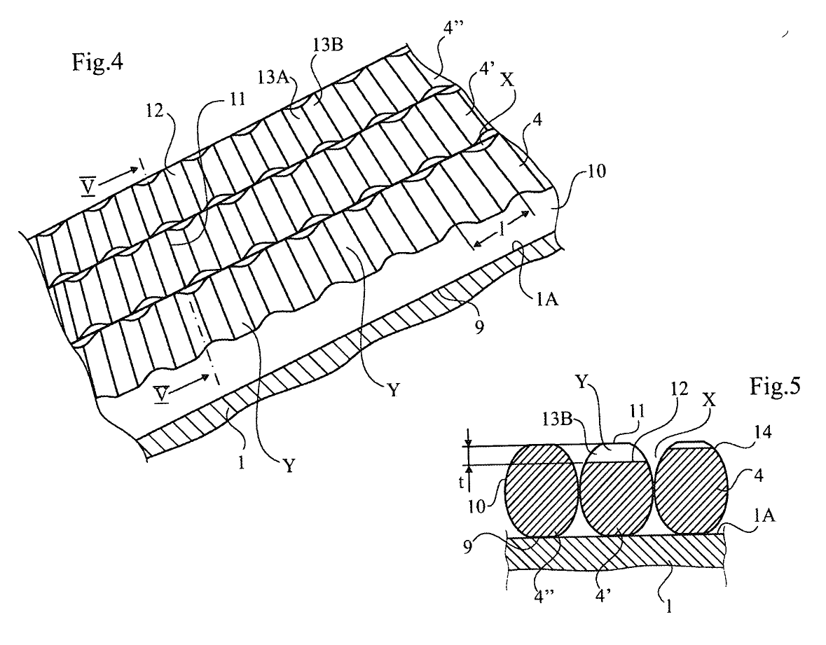

FIGS. 4 and 5 show a first modified embodiment of the invention. The principles are basically the same as already described in connection with FIGS. 2 and 3, and hence only the important differences will be described in detail. Firstly, it can be noted that the lateral room Y in the outwardly directed surface of each wire 4 is provided with a lowermost level 12 in the form of a flat surface. Accordingly, a larger room Y is formed here, between two adjoining peaks 11, as compared to that shown in FIGS. 2 and 3. It is also clear that the toothed structure is achieved by curved surfaces 13A, 13B, as opposed to the flat/planar surfaces in FIGS. 2 and 3. In addition, it is clear that also the side surfaces 10 are formed of curved surfaces, whereby the longitudinal channel X is “automatically” formed. In this embodiment too, a planar surface has been embossed at the rear edge, but it extends only along a limited portion of the cross-sectional dimension of a wire 4.

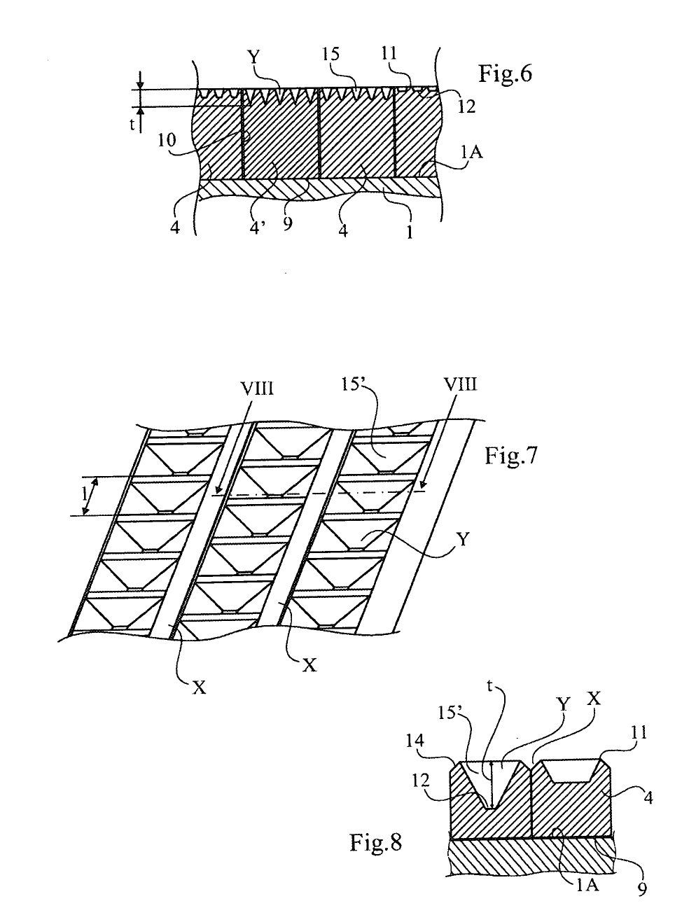

FIG. 6 shows yet another modified embodiment which is also basically based on the same principles as above. A first important difference of the embodiment is that the wires 4 are of completely rectangular shape, such that a tight contact is achieved along the entire side surfaces 10 and also between the back surface 9 and the envelope surface 1A of the roller. Another important difference is that pluralities of closed cells 15, in the form of acute-angled pyramids, have been embossed in the outwardly facing surface of each wire 4. As is shown, a plurality of such embossing 15 is arranged laterally on each wire 4, such that a plurality of closed cells is formed having lateral closed rooms Y in each cross-section of the wire. As seen in the longitudinal direction, these pyramid shaped depressions 15 are suitably also arranged close to each other, suitably with about the same spacing as in the lateral direction, such that a large number of closed rooms are formed in the roller surface 1. As is shown, the upper surface 11 of the wire forms the upper limit and the tip 12 of the pyramid forms the lower portion of the room Y. The depth of the embossing varies between about 0.01 and 1 mm. The base of the pyramid shaped depressions is usually of square shape and suitably it has side dimensions of about 0.1-0.5 mm.

FIGS. 7 and 8 show yet another modified embodiment according to the general principles of the invention, according to the above. In principle, the embodiment of FIGS. 7 and 8 can be seen as a kind of combination between what is shown in FIG. 6 and FIGS. 2-5, as completely closed rooms Y are used which are formed by a pyramid shaped embossing 15′ (similar to that shown in FIG. 6), as well as bevelled side surfaces 14, such that longitudinal channels X are formed (in accordance to that shown in FIGS. 2-5). One important difference in relation to FIG. 6 is that each embossing 15′ is large enough for only a single embossing to be used in the lateral dimension, such that it extends laterally in the top surface 11 (that forms the upper limit of the room Y) for more than 50% of the lateral width of the wire 4. (According to the embodiment of FIG. 6 the corresponding lateral extension is only about 10-20%). Hence it is realised that an embossing pattern according to FIGS. 7 and 8 normally enables the dosing out of a larger amount of coating liquid than does an arrangement according to FIG. 6 when the peripheral speed of the roller 1 is the same.

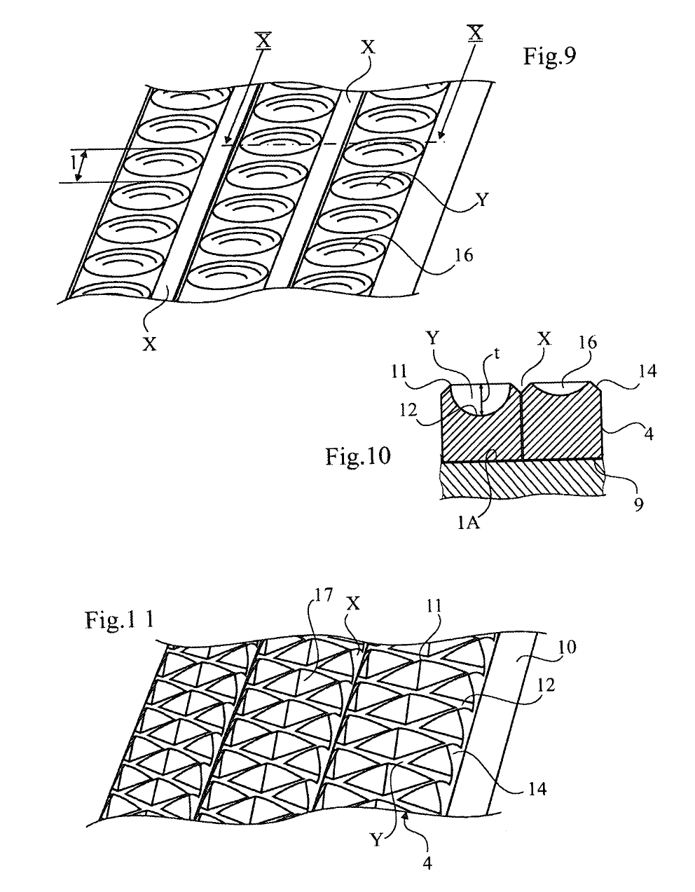

FIGS. 9 and 10 show yet another modified embodiment according to the invention, which also functions mainly according to the principles described above, the important difference being that instead of the pyramid shaped embossing a spherical shape is used here, i.e. an embossing 16 that essentially has the shape of half spheres.

FIG. 11 shows yet a modification according to the invention, utilising a pyramid shaped embossing pattern 17, the embossing pattern however being inverted in relation to that shown in FIGS. 6-8, such that the tips of the pyramid shaped parts 17 is level with the uppermost point of the embossing pattern. Accordingly, a type of grid shaped and planar structure 12 is formed between the pyramid shaped structures 17, which planar structure 12 forms the lowermost level in the rooms Y formed for the coating mix. Also in the embodiment shown in FIG. 11, bevelled side surfaces 14 have been arranged that form longitudinal channels X.

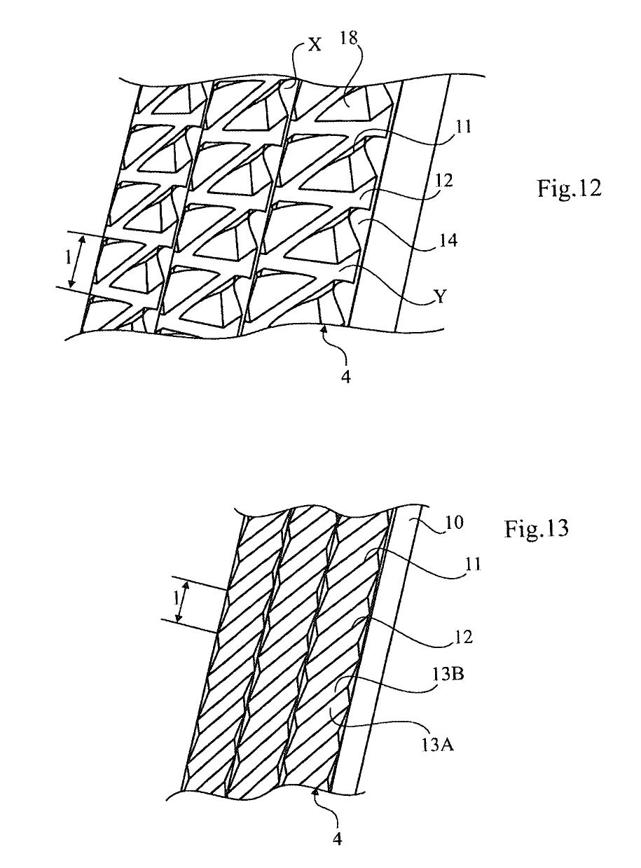

FIG. 12 shows yet another embodiment in which elements 18 are directed upwards in the embossing pattern. Here, the elements 18 are not of true pyramid shape but have a highest point 11 that extends as a line. As is clear from FIG. 12, the elements 18 can be positioned differently in relation to the direction of the wire, i.e. at right angle or obliquely in relation to the extension of the wire, whereby in FIG. 12 the line 11 extends about 45° in relation to the extension of the wire. It is realised that this angle can be varied between 0 and 90° depending on the desired properties, and also the shape of the embossing. Accordingly, it is realised that the angle of e.g. toothed patterns according to FIGS. 2-5 also can be varied in respect of the angle, as is clear from the modification indicated in FIG. 13.

The invention is not limited to the embodiments described above but may be varied within the scope of the claims. For example, the person skilled in the art will realise that many different types of patterns can be used to achieve a function according to the invention. It is accordingly realised that a combination of the different types of patterns shown in the figures can be used, and that the mutual relation between the spacing 1 and the depth t also can be varied within wide boundaries in order to provide different types of properties, for example depending on specific desires of the customer. It is also realised that various types of material can be used, within wide boundaries, for the wire 4, among other things also to be able to achieve different types of properties, for example in respect of wear and/or the ability to emboss, etc. Of course, the cost aspect is a factor that is not irrelevant in this connection, and it may control the choice of material for the wire 4. It is also realised that many types of known embossing or forming methods can be used in order to give the wire a desired cross-section/pattern. It is also realised that the invention is not limited to the use of a wire of a given initial shape, but that within the scope of the invention the method is easily adapted to different types of initial shapes, such as round, oval, square etc.

The person skilled in the art will realise that the principle can be used also for rotary rods for smaller embossing.

1. A method in connection with the manufacturing of a dosing roller, comprising the provision of a roller body (1) with an envelope surface (IA) on which a wire (4) is being wound such that plurality of turns of wire is formed in contact with the envelope surface (IA) and with adjoining turns of wire (4, 4′, 4″) in tight contact with each other, characterised in that for at least the major part of said adjoining turns of wire (4, 4′, 4″) the surface of the wire (4) which is outwardly exposed is being provided with protrusions (11) and depressions (12).

2. A method according to claim 1, characterised in that said protrusions (11) and said depressions (12) are arranged such that at least partly delimited rooms (Y) are formed in said outwardly exposed surface of the roller (1).

3. A method according to claim 1, characterised in that two adjacent peaks (11), as seen in the longitudinal direction of the wire (4), are arranged with a spacing (1) of between 0.05 and 3 mm, preferably 0.1-0.8 mm.

4. A method according to claim 1, characterised in that the depth (t) between said protrusion (11) and said depression (12) is between 0.01 and 2 mm, preferably 0.02-0.2 mm.

5. A method according to claim 1, characterised in that bevelled side surface portions (14) are arranged at the transition between the upper surface of the wire (4) and the respective side surfaces (10), which bevelled surfaces (14) form a continuous channel (X) between each pair of adjoining wires.

6. A method according to claim 1, characterised in that shaping of the wire is performed in direction connection with the application of the wire (4) on top of the envelope surface (IA).

7. A method according to claim 1, characterised in that pre-shaping and suitable storing of the wire (4) in order to enable subsequent application of the wire without the need of simultaneous shaping.

8. A dosing roller adapted for the pre-dosing or direct dosing of a coating mix on a running web, comprising a roller body (1) having an envelope surface (IA) on which a wire (4) is arranged with a plurality of turns of wire with adjoining turns of wire (4, 4′, 4″) in tight contact with each other, characterised in that for at least the major part of said adjoining turns of wire (4, 4′, 4″) the surface of the wire (4) which is outwardly exposed is provided with protrusions (11) and depressions (12).

9. A dosing roller according to claim 8, characterised in that said depressions (12) are arranged such that at least partly delimited rooms (Y) are formed between said protrusions (11) in said outwardly exposed surface of the roller (1).

10. A dosing roller according to claim 8, characterised in that two adjacent peaks (11), as seen in the longitudinal direction of the wire (4), are arranged with a spacing (1) of between 0.05 and 3 mm, preferably 0.10-0.8 mm.

11. A dosing roller according to claim 8, characterised in that the depth (t) between said protrusion (11) and said depression (12) is between 0.01 and 2.00 mm.

12. A dosing roller according to claim 8, characterised in that bevelled side surfaces (14) are arranged at the transition between the upper surface of the wire (4) and the respective side surfaces (10), in order to form a continuous channel (X) between each pair of adjoining wires.

13. A dosing roller according to claim 8, characterised in that the diameter of the roller is between 8 and 2,000 mm, more preferred 80-1,500 mm.

14. A dosing roller according to claim 8, characterised in that the horizontal cross-section of said wire is between 0.1 and 10 mm.

15. A dosing roller according to claim 1, characterised in that the vertical cross-section of said wire is between 0.1 and 3 mm.

16. A dosing roller according to claim 8, characterised in that at least some of the side surfaces (10) and/or the backside surface (9) are at least partly flat.

17. A dosing roller according to claim 8, characterised in that at least some of said rooms (Y) form closed cells (15, 16, 17).

18. A dosing roller according to claim 17, characterised in that said protrusion (11) is composed of a continuous surface.

19. A dosing roller according to claim 8, characterised in that said protrusion (11) is provided at a part element that has at least two side surfaces (13A, 13B) the normals of which are diverging.

20. A dosing roller according to claim 19, characterised in that said part element extends between the respective side limits (10; 14) of the respective wire (4).

21. A dosing roller according to claim 19, characterised in that said protrusion (11) is arranged at a part element the side surfaces (13A, 13B) of which only extending a limited portion of the distance between the respective side limits (10; 14) of said wire (4).
